(19) United States
(12) Patent Application Publication
(10) Pub. No.: US 2015/0273476 A1
(43) Pub. Date: Oct. 1, 2015

(54) GARBAGE SHREDDING PROCESS AND PRODUCTS

(71) Applicant: Donna K. Jackson, Fort Worth, TX (US)

(72) Inventor: Donna K. Jackson, Fort Worth, TX (US)

(21) Appl. No.: 14/672,056

(22) Filed: Mar. 27, 2015

Related U.S. Application Data
(60) Provisional application No. 61/971,406, filed on Mar. 27, 2014.

(51) Int. Cl. B02C 4/04; B02C 25/00; B02C 23/08

(52) U.S. Cl. CPC B02C 4/04; B02C 23/08; B02C 25/00

(57) ABSTRACT

The invention relates generally to systems for waste management, and, more particularly, to systems and methods for processing and storing waste for subsequent use in biofuel conversion processes.

### CROSS-REFERENCE TO RELATED APPLICATIONS

This application is a non-provisional application that claims the benefit of, and priority to, U.S. Provisional Application Ser. No. 61/971,406, filed Mar. 27, 2014, the contents of which are incorporated by reference herein in their entirety.

### FIELD OF THE INVENTION

This invention relates generally to systems for waste management, and, more particularly, to systems and methods for processing and storing waste for subsequent use in biofuel conversion processes.

### BACKGROUND OF THE INVENTION

Biofuels have increased in popularity because of rising oil prices and the need for energy security. Biofuel is a type of fuel derived from organic matter (e.g., obtained directly from plants, or indirectly from agricultural, commercial, domestic, and/or industrial wastes). One particular avenue being explored is the use of food waste, which is readily available and can be converted into biofuel through various processes.

It is estimated that the food industry accounts for 8% of all the energy used in the United States, and studies have found that over 27% of this food is thrown away. Not only do these actions neglect a valuable source of energy, but presents an inefficient use of the energy invested in producing the food in the first place. In fact, food comprises one of the largest components of waste in the United States. However, less than 3% of the food waste generated in the United States is recycled. The rest of this waste is decomposed in landfills where it produces foul odors, can pollute groundwater, and requires large amounts of space. With the realization that millions of tons of food waste is being hurled into landfills every year, the recycling of food waste has become one of the most environmentally friendly processes for generating biofuels. In fact, the conversion of food waste into biofuels it is a much better alternative to growing crops for the purpose of generating biofuel.

There are many systems in place for handling and managing the collection and disposal of waste. However, current systems lack the ability to easily accommodate the build-up of food waste that could be readily used as reclaimed matter for generating biofuels or other forms of energy in a way that is economically feasible, or generates substantial quantities needed for alternative energy sources without burdensome cost and timing issues. For example, some systems have been developed that attempt to reduce the volume of garbage generated at a site. For example, some systems utilize compacting devices for condensing waste into smaller, more manageable volumes. However, such known devices are subject to certain disadvantages which detract from their usefulness. Particularly, the devices are incapable of continually handling the garbage and trash without failure of their mechanisms. Additionally, in the case of devices directed to treat and condense food wastes, the introduction of non-food waste, including bones, plastics, papers, silverware, etc., further increases the possibility of mechanical failure. Moreover, the prior devices are deficient in sufficiently managing and condensing the waste material for subsequent handling processes, particularly by biofuel plants to be transformed into useable fuels.

### BRIEF SUMMARY OF THE INVENTION

The present invention provides improved systems and methods for processing and storing waste for subsequent use in biofuel conversion processes. The present invention specifically provides for a system for collecting and processing refuse, specifically food waste, for subsequent use as an alternative energy source. In one embodiment, for example, a portable modular waste processing system is provided. The system includes a top housing member housing a mechanical processing assembly configured to process waste to generate concentrated waste for subsequent use as a base fuel or substrate for energy generation. The system further includes a bottom housing member releasably coupled to the top housing member and housing at least two receptacles configured to receive and store the concentrated waste. The system is portable in the sense that it may be easily movable within an establishment for the collection of food waste (e.g., restaurant, food court, hotel, etc.).

The mechanical processing assembly may generally include a collecting mechanism having a magnetized member configured to separate metallic material from waste by way of magnetic attraction and a collection tray configured to receive and retain the metallic material. Accordingly, the system of the present invention is well-suited for the collection and processing of food waste, particularly in instances where users dispose of food concurrently with utensils (e.g., forks, knives, spoons), such as at a restaurant or other food establishment. The collecting mechanism is configured to separate metal utensils from the food or paper waste that a user (e.g., patron, employee, etc.) may be disposing of. The mechanical processing assembly may further include a cutting mechanism configured to cut, grind, shear, or pulverize the waste into a manageable concentrated waste. Accordingly, by separating at least metallic material from the waste, the system is able to prevent the opportunity for metallic material from entering the cutting assembly, thereby extending the life of the cutting mechanism and reducing the opportunity for failure.

The concentrated waste is then provided into the receptacles. The receptacles are able to be removed from the bottom housing member when they are full, such that the concentrated waste within may be transported to a processing facility to be converted into biofuels, or other alternate fuels. The receptacles may be composed of a recyclable material, thereby further increasing the environmental friendly aspects of the system of the present invention.

Accordingly, the system of the present invention provides for a relatively simple and straightforward means of processing food waste to be converted into an alternative energy source. In addition to providing an affordable and cost efficient means of processing food waster for biofuel conversion, the systems and processes of the present invention also create new jobs through a unique and environmentally sound way to dispose of and up cycle food waste of all nature.

In certain aspects, the present invention provides an apparatus for collecting and processing refuse for subsequent use as an alternative energy source. The apparatus includes a top housing member comprising an opening configured to receive refuse therethrough. The apparatus further includes a processing assembly housed within the top member and configured to receive and process the refuse to generate concentrated waste for subsequent use as a base fuel or substrate for energy generation. The apparatus further includes a bottom housing member configured to be coupled to the top housing member and receive concentrated waste therefrom. The bottom housing member is configured to house at least one receptacle within for receiving and storing the concentrated waste.

In some embodiments, the top housing member includes a trough configured to guide refuse from the first opening towards the processing assembly. The trough lies along a plane that forms an oblique angle relative to a substantially vertical plane when the top and bottom housing members are coupled to one another and the apparatus is at address. In some embodiments, the oblique angle is in the range of 25 to 75 degrees. In one embodiment, the oblique angle is approximately 45 degrees. The trough is positioned within the top housing member and insulated from user contact therewith.

In some embodiments, the processing assembly may include a collecting mechanism configured to separate at least metallic material from the received refuse, a cutting mechanism configured to partition the received refuse into smaller portions, and a motor configured to drive at least the cutting mechanism. The collecting mechanism may include a magnetized member configured to collect metallic material from refuse as the refuse travels towards the cutting mechanism by way of magnetic attraction. The processing assembly may further include a collection tray configured to receive the metallic material separated from the refuse. The cutting mechanism may include a roll mill having at least two rollers configured to cut, grind, shear, or pulverize the refuse into concentrated waste.

In some embodiments, the processing assembly may further include control circuitry configured to provide power to and control operation of at least the motor. In some embodiments, the apparatus may include at least one sensor module in electronic communication with the control circuitry and configured to sense the receipt of refuse within the top housing member. Operation of the motor and cutting mechanism may be based on a sensing signal from the sensor module. Additionally, or alternatively, the apparatus may include at least one sensor module in electronic communication with the control circuitry and configured to sense proper loading of the at least one receptacle within the bottom housing member and in proper alignment with the processing assembly. Operation of the motor and cutting mechanism may be based on a sensing signal from the sensor module.

The at least one receptacle is generally removable from the bottom housing member. For example, in one embodiment, the bottom housing member may include one or more doors that may be opened so as to provide access to the interior of the bottom housing member and allow for the removal and insertion of the receptacles. In some embodiments, the at least one receptacle may be composed of a recyclable material. Furthermore, the at least one receptacle may include a pop-up valve indicator configured to provide an indication of gas buildup within the receptacle. The at least one receptacle may further include a sensing module configured to provide an audible or visual indication that the receptacle is full.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### BRIEF DESCRIPTION OF THE DRAWINGS

FIG. 1 is a front perspective view of an apparatus consistent with the present disclosure.

FIG. 2 is an exploded perspective view of the apparatus of FIG. 1 illustrating the modular nature of the apparatus.

FIG. 3 is a perspective view of an underside of the top housing member of the apparatus of FIG. 1.

FIG. 4 is a front perspective view, partly in section, of the apparatus of FIG. 1 illustrating the internal workings of the apparatus consistent with the present disclosure.

FIG. 5 is a side sectional view of the apparatus of FIG. 1 illustrating the processing of refuse by the mechanical processing assembly.

FIGS. 6A and 6B are top and bottom perspective views of one embodiment of a cutting assembly consistent with the present disclosure.

FIG. 7 is a front perspective view of the apparatus of FIG. 1 illustrating the removal of a receptacle from the bottom housing member.

FIG. 8 is a perspective view of one embodiment of a receptacle for use with the apparatus of the present disclosure.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

By way of overview, the present invention is generally directed to improved systems and methods for processing and storing waste for subsequent use in biofuel conversion processes. The present invention specifically provides for a system for collecting and processing refuse, specifically food waste, for subsequent use as an alternative energy source. In one embodiment, for example, a portable modular waste processing system is provided. The system includes a top housing member housing a mechanical processing assembly configured to process waste to generate concentrated waste for subsequent use as a base fuel or substrate for energy generation. The system further includes a bottom housing member releasably coupled to the top housing member and housing at least two receptacles configured to receive and store the concentrated waste. The system is portable in the sense that it may be easily movable within an establishment for the collection of food waste (e.g., restaurant, food court, hotel, etc.).

The mechanical processing assembly may generally include a collecting mechanism having a magnetized member configured to separate metallic material from waste by way of magnetic attraction and a collection tray configured to receive and retain the metallic material. Accordingly, the system of the present invention is well-suited for the collection and processing of food waste, particularly in instances where users dispose of food concurrently with utensils (e.g., forks, knives, spoons), such as at a restaurant or other food establishment. The collecting mechanism is configured to separate metal utensils from the food or paper waste that a user (e.g., patron, employee, etc.) may be disposing of. The mechanical processing assembly may further include a cutting mechanism configured to cut, grind, shear, or pulverize the waste into a manageable concentrated waste. Accordingly, by separating at least metallic material from the waste, the system is able to prevent the opportunity for metallic material from entering the cutting assembly, thereby extending the life of the cutting mechanism and reducing the opportunity for failure.

The concentrated waste is then provided into the receptacles. The receptacles are able to be removed from the bottom housing member when they are full, such that the concentrated waste within may be transported to a processing facility to be converted into biofuels, or other alternate fuels. The receptacles may be composed of a recyclable material, thereby further increasing the environmental friendly aspects of the system of the present invention.

Accordingly, the system of the present invention provides for a relatively simple and straightforward means of processing food waste to be converted into an alternative energy source. In addition to providing an affordable and cost efficient means of processing food waster for biofuel conversion, the systems and processes of the present invention also create new jobs through a unique and environmentally sound way to dispose of and up cycle food waste of all nature.

Expressly incorporated herein by reference as if fully set forth herein are: U.S. Publication No. 2007/0298488 filed Dec. 27, 2007; U.S. Publication No. 2007/0029247 filed Feb. 8, 2007; U.S. Publication No. 2005/0247647 filed Nov. 10, 2005; U.S. Publication No. 2005/0028689 filed Feb. 10, 2005; U.S. Publication No. 2004/0206698 filed Oct. 21, 2004; U.S. Publication No. 2003/0183094 filed Oct. 21, 2004; U.S. Publication No. 2003/0006327 filed Jan. 9, 2003; U.S. Publication No. 2003/0003568 filed Jan. 2, 2003; U.S. Pat. No. 7,296,693 filed on Nov. 11, 2007; U.S. Pat. No. 7,108,788 filed Sep. 19, 2006; U.S. Pat. No. 6,925,928 filed on Aug. 9, 2005; U.S. Pat. No. 6,640,701 filed Nov. 4. 2003; and U.S. Pat. No. 5,538,143 filed on Jul. 23, 1996.

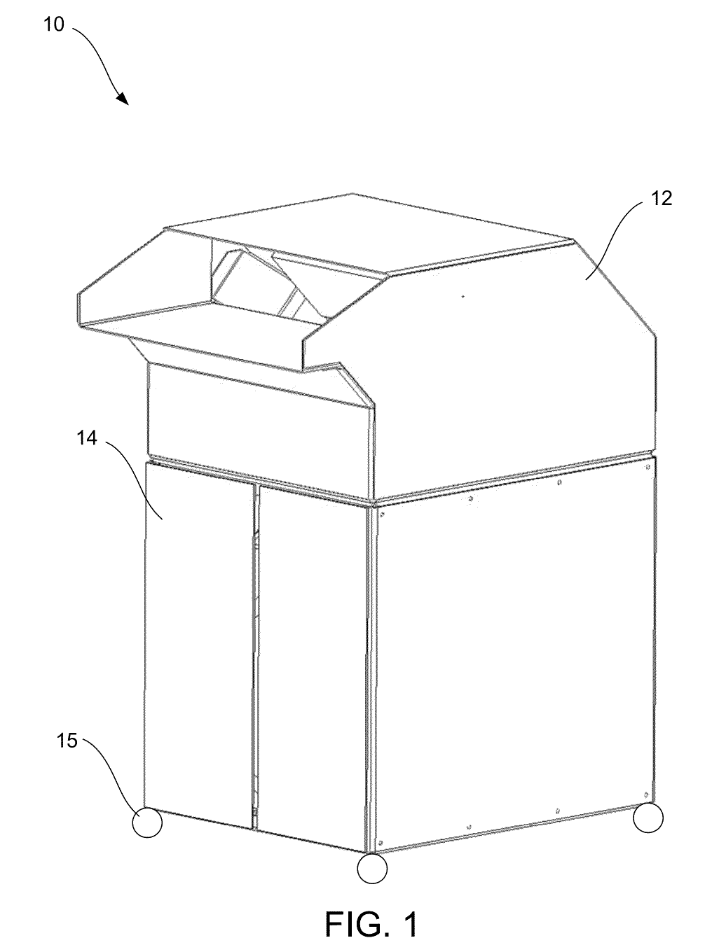

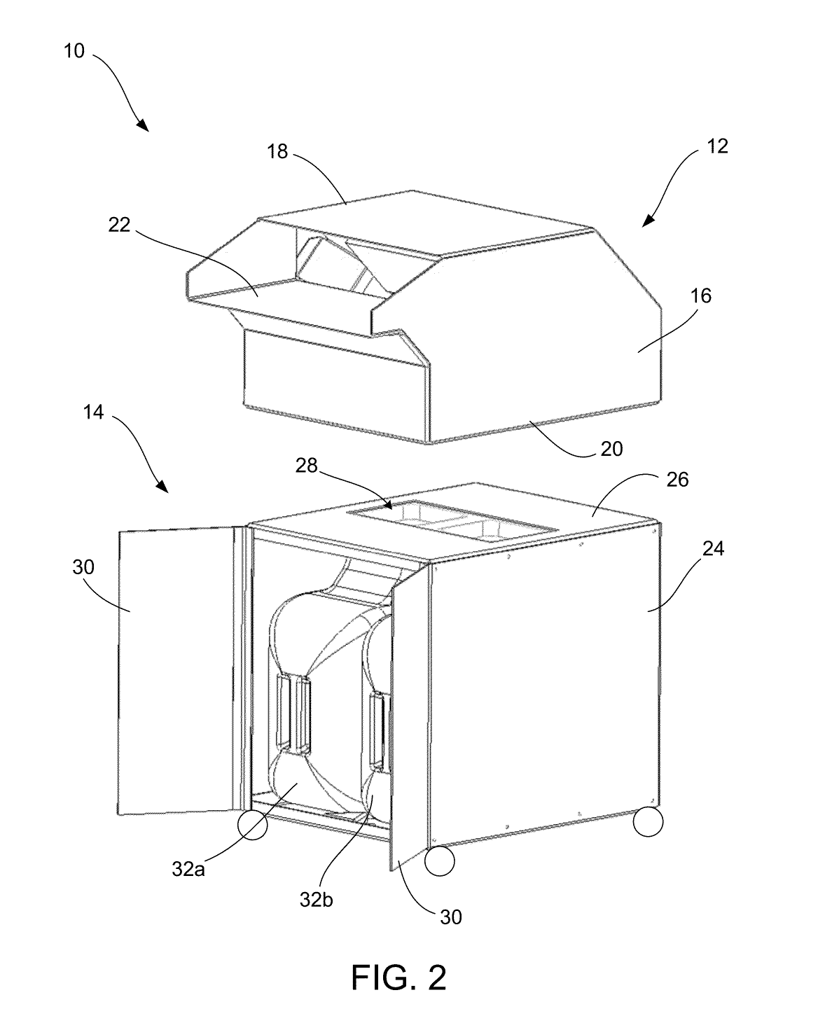

FIG. 1 is a front perspective view of an apparatus 10 consistent with the present disclosure and FIG. 2 is an exploded perspective view of the apparatus 10 illustrating the modular nature of the apparatus 10. As shown, the apparatus 10 may be of a modular nature, such that the apparatus 10 includes a top housing member 12 and a bottom housing member 14 configured to be releasably coupled to one another. As shown, the apparatus 10 may include wheels 15, for example, so as to allow the apparatus 10 to be easily moved from one location to another, thereby lending to the portable nature of the apparatus.

As shown in FIG. 2, the top housing member 12 generally includes a body 16 having a top end 18 and a bottom end 20 (in addition to sidewalls) so as to form a cavity within. The top housing member 12 further includes an opening 22 formed proximate the top end 18 and configured to receive refuse therethrough such that the refuse is receive within the interior of the top housing member 12. As will be described in greater detail herein, the top housing member 12 further houses a processing assembly within, wherein the processing assembly is configured to receive and process the refuse and generate concentrated waste for subsequent use as a base fuel or substrate for energy.

The bottom housing member 14 generally includes a body 24 having a top end 26 configured to be coupled to the corresponding bottom end 20 of the top housing member 12. The bottom housing member 14 further includes an opening 28 defined on the top end 26, wherein the opening 28 is configured to receive the concentrated waste generated by the processing assembly. More specifically, the bottom housing member 14 is configured to house one or more receptacles 32a, 32b within, wherein such receptacles 32 are configured to receive and store the concentrated waste. As shown, the bottom housing member 14 includes one or more doors 30, or other removable portions, that allow a user access to the interior of the bottom housing member 14 and further gain access to the receptacles 32. Accordingly, the receptacles 32 are able to be accessed and exchanged from the bottom housing member 14 via the doors 30. A user may further gain access to the interior components within.

It should be noted that the figures show a basic design whereby refuse, for example, restaurant refuse, can be held, stored gathered for later pick-up by a truck, trucking system or alternate means for transporting the same to an alternate energy generating facility. Those skilled in the art readily understand that systems for transport can either interface directly with the receptacles (removing their respective contents with suction, fluidics and the like mechanisms) or move the receptacles themselves.

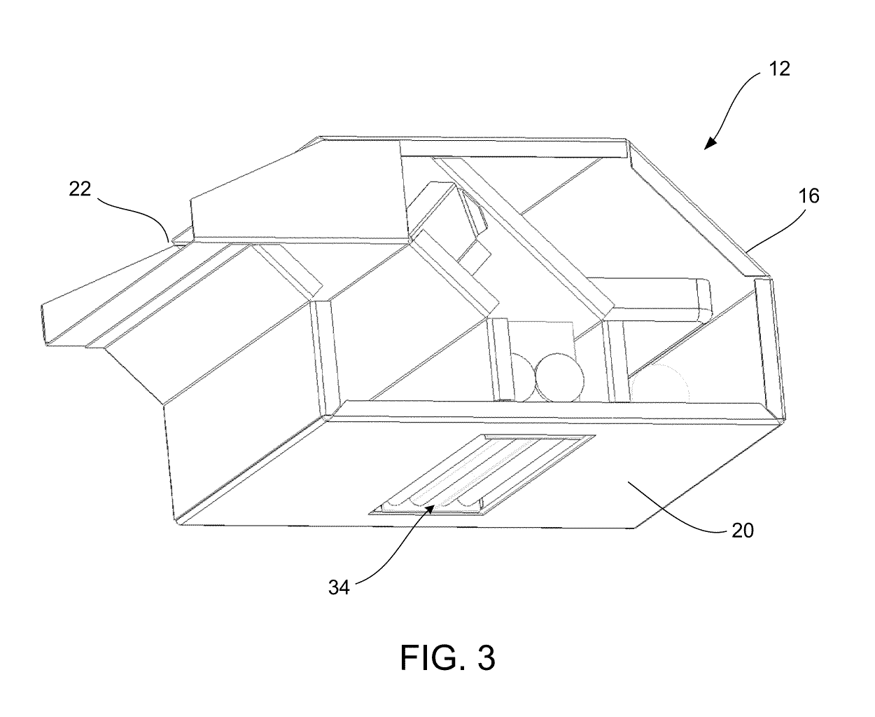

FIG. 3 is a perspective view of the bottom end 20 (or underside) of the top housing member 12. As shown, a second opening 34 may be formed in the bottom end 20. The second opening 34 is generally in fluid communication with the opening 28 formed on the top end 26 of the bottom housing member 14 when the top and bottom housing members 12, 14 are coupled to one another. Accordingly, concentrated waste is able to pass from the top housing member 12 to the bottom housing member 14 and into the receptacles 32 by passing through the corresponding openings 34 and 28. The bottom housing member 14 interior is shaped and/or sized so as to accept each receptacle 32 in a certain fashion so as to ensure that that the opening of each receptacle 32 is guided into proper alignment with the opening 28 on the top end 26 of the bottom housing member 14 upon full insertion each receptacle 32 within the interior of the bottom housing member 14. For example, the interior of the bottom housing member 14 is shaped and/or sized to receive two receptacles 32a, 32b within in a side-by-side arrangement and the opening 28 is sufficiently shaped so as to be in alignment with the openings of the receptacles 32a, 32b once they are fully positioned within the interior of the bottom housing member 14.

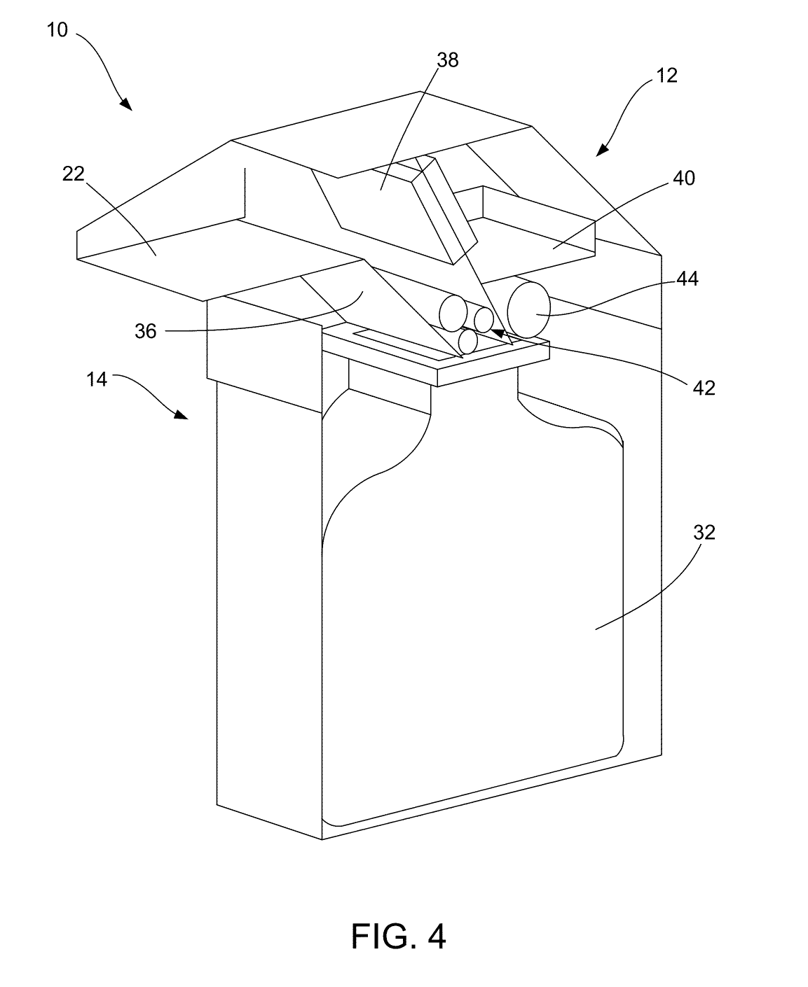

FIG. 4 is a front perspective view, partly in section, of the apparatus 10 illustrating the internal workings of the apparatus 10. In particular, FIG. 4 illustrates one embodiment of a processing assembly consistent with the present disclosure. As previously described, the processing assembly is housed within the top housing member 12 and configured to receive and process the refuse received through the opening 22 so as to generate concentrated waste for subsequent use as a base fuel or substrate for energy generation. As shown, the top housing member 12 generally includes a trough 36 configured to guide refuse from the opening 22 towards the processing assembly. As will be described in greater detail herein, the trough 36 is positioned within the top housing member 12 in such a way so as to insulate a user from contact therewith so as to prevent accidental injury should the user attempt to place their hand, or other appendage within the apparatus 10.

The processing assembly may include a collecting mechanism 38 configured to separate at least metallic material from the received refuse. For example, the collecting mechanism 38 may include a magnetized member configured to collect metallic material from refuse as the refuse by way of magnetic attraction. A collection tray 40 may be positioned adjacent to the collection mechanism 38 and may be configured to receive the metallic material separated from the refuse. The processing assembly may further include a cutting mechanism 42 configured to partition the received refuse into smaller portions. It should be noted that the cutting mechanism may include any number of cutting, grinding, pulverizing, shearing, or other implements configured to assist in the breakdown of refuse into smaller parts. The processing assembly may further include a motor 44 configured to drive at least the cutting mechanism 42. In the illustrated embodiment, the cutting mechanism 42 generally resembles a rolling mill, thus the motor 44 is configured to drive the rotation of the rollers of the rolling mill, as will be described in greater detail herein. The motor 44 may be an electrically powered motor. Accordingly, the apparatus 10 may include proper circuitry configured to provide electricity from and electrical source (e.g., electrical outlet) to the motor 44. It should be noted that the motor 44 may be run off of 110 V or 220 V. It should further be noted that, in alternative embodiments, the motor 44 may be embodied as an internal combustion motor 44 configured to run off of conventional fuels.

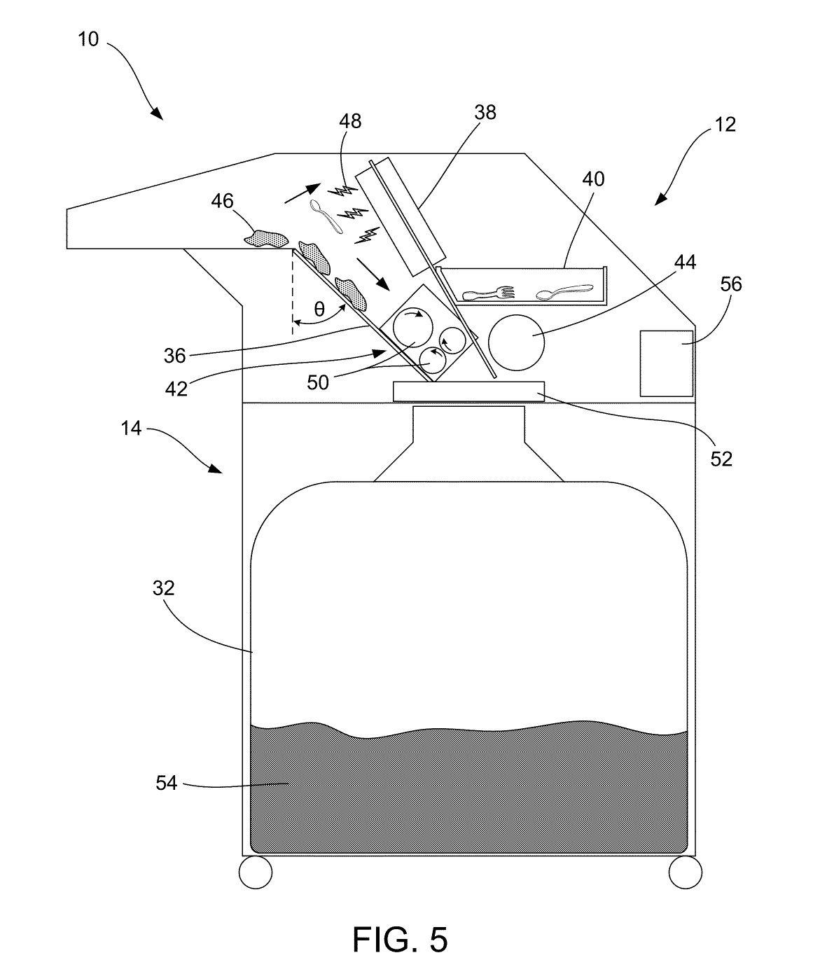

FIG. 5 is a side sectional view of the apparatus 10 illustrating the processing of refuse by the mechanical processing assembly. As shown, refuse material 46 may enter the top housing member 12 at the opening 22, such that the trough 36 may further guide the refuse 46 towards one or more components of the processing assembly. As previously described, the trough 46 may be positioned in such a manner that it insulates a user from making contact therewith and prevents further contact with any of the working components of the processing assembly within, thereby reducing risk of accidental injury when placing refuse within the apparatus 10.

For example, the trough 36 may lie along a plane that forms an oblique angle θ relative to a substantially vertical plane when the top and bottom housing members 12, 14 are coupled to one another and the apparatus is at address, as shown in FIG. 5. In some embodiments, the oblique angle θ is in the range of 25 to 75 degrees. In one embodiment, the oblique angle θ is approximately 45 degrees. Furthermore, the trough 36 may be designed with a “wave” construction in order to prevent a user's hand, or other appendage, from entering the working components.

As the refuse 46 travels down the trough 36 and is guided towards the cutting mechanism 42, the magnetized member of the collecting mechanism 38 is configured to collect metallic material from refuse 46 (e.g., silverware) by way of magnetic attraction 48 as the refuse 46 travels towards the cutting mechanism 42. As shown, the collection tray 40 may be configured to receive the silverware that was separated from the refuse 46.

The cutting mechanism 42 in FIG. 5 is shown as a roll mill having at least two rollers 50 configured to cut, grind, shear, or pulverize the refuse 46 into concentrated waste. As generally understood, the rollers 50 may include any number of and/or arrangement of cutting teeth or grinding members configured to break refuse 46 into smaller pieces. Furthermore, the motor 44 is configured to drive the rollers 50 in a predetermined rotation, some rotating in different directions, as generally understood. The motor 44 may further include a shaft that is either cylindrical with a keyed slot or square, so as to offset the roller blades for improved balance and pressure. The blades will be dynamically designed with an extra set of teeth on the gears to “grab” the food and keep the pulverization process ongoing. The back of the area where the blades sit will also contain either teeth or blades to keep food from falling without being ground into particles. The motor 44 may include anything from 1 hp or greater. Accordingly, the motor 44 may be configurable for whatever torque and power necessary so as to accommodate different sizes of apparatus 10 and working conditions. A guide or lid 52 may further be provided and configured to guide concentrated waste into the bottom housing member 14. As previously described, the concentrated waste 54 may then be received and stored within the receptacles 32.

The processing assembly may further include control circuitry configured to provide power to and control operation of at least the motor 44. As generally understood, the control circuitry 56 may be configured to provide the electrical power to the motor 44 so as to allow components of the processing assembly to operate. The control circuitry 56 may be automatically configured to control operation of the motor 44 and cutting mechanism 42 based on safety measures (e.g., fully closed doors 30, proper alignment of the receptacles 32 within the bottom housing member 14, sensed amount of refuse 46 on the trough 36, etc.). In some embodiments, the control circuitry 56 may be manually controlled by a user (e.g., on/off switch).

For example, in one embodiment, the apparatus may include at least one sensor module in electronic communication with the control circuitry 56 and configured to sense the receipt of refuse within the top housing member 12. For example, a weight sensor module coupled to the trough 36 and may be configured to sense the weight of refuse 46 on the trough, whereby operation of the motor 44 and cutting mechanism 42 is based on an activation signal from the weight sensor module to the control circuitry 46, such that the control circuity 56 will activate the motor 44 when a certain weight is achieved. In another example, at least one sensor module may be included that is configured to sense proper loading of the receptacle 32 within the bottom housing member 14. In particular, the sensor may be configured to determine whether the receptacle 32 is in proper alignment within the interior of the bottom housing member 14, and thus in proper alignment to receive the concentrated waste 54. Accordingly, operation of the motor 44 and cutting mechanism 42 may be based on a sensing signal from the sensor module only when the receptacle is fully positioned within the bottom housing member 14.

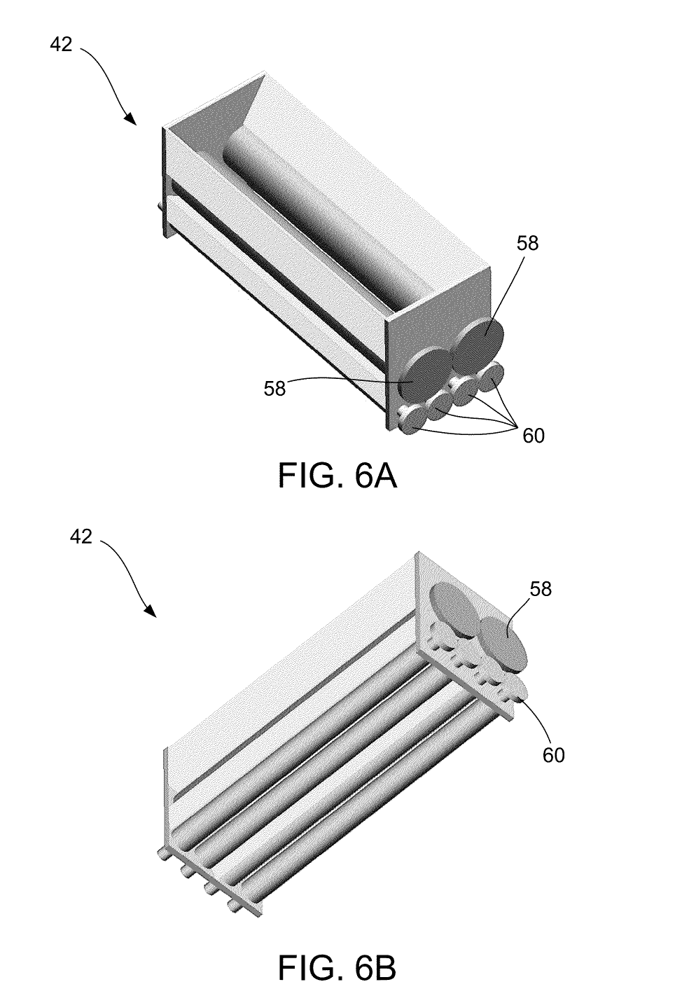

FIGS. 6A and 6B are top and bottom perspective views of one embodiment of a cutting assembly 42 consistent with the present disclosure. As previously described, the cutting mechanism 42 may resemble a roll mill having different rollers 58, 60 configured to cut, shear, grind, or otherwise pulverize the refuse.

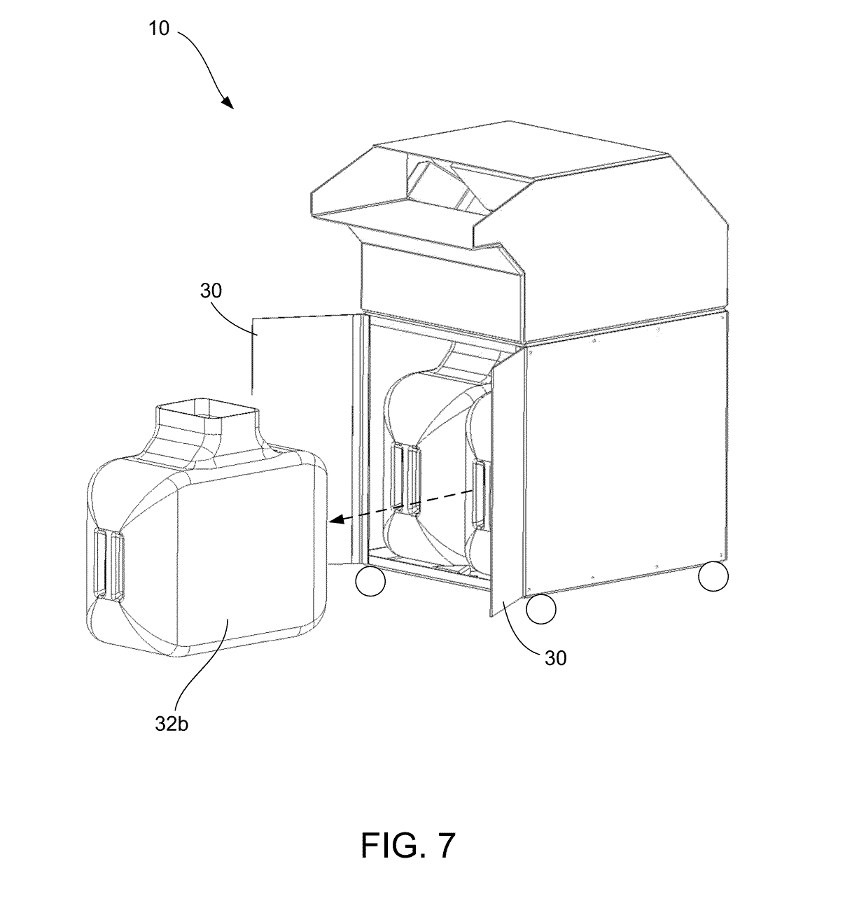

FIG. 7 is a front perspective view of the apparatus 10 illustrating the removal of a receptacle 32 from the bottom housing member. As

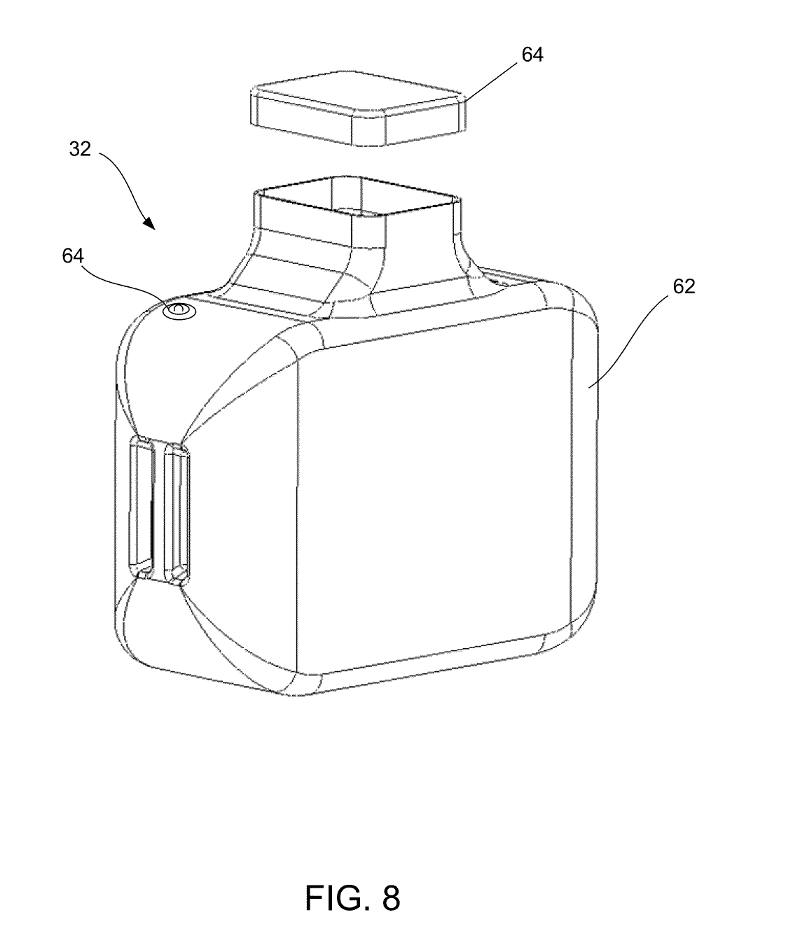

FIG. 8 is a perspective view of one embodiment of a receptacle 32 for use with the apparatus 10 of the present disclosure. As shown, receptacle 32 may include a body 62, which may include a geometric shaped canister body 62 and a corresponding lid 64 configured to cover the opening. The receptacle 32 may further include a pop-up valve 64 to provide indication of gas buildup.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. An apparatus for collecting and processing refuse for subsequent use as an alternative energy source, the apparatus comprising:
a top housing member comprising an opening configured to receive refuse therethrough;
a processing assembly housed within the top member and configured to receive and process the refuse to generate concentrated waste for subsequent use as a base fuel or substrate for energy generation; and
a bottom housing member configured to be coupled to the top housing member and receive concentrated waste therefrom, the bottom housing member configured to house at least one receptacle within for receiving and storing the concentrated waste.

2. The apparatus of claim 1, wherein the top housing member further comprises a trough configured to guide refuse from the first opening towards the processing assembly.

3. The apparatus of claim 2, wherein the trough lies along a plane that forms an oblique angle relative to a substantially vertical plane when the top and bottom housing members are coupled to one another and the apparatus is at address.

4. The apparatus of claim 3, wherein the oblique angle is in the range of 25 to 75 degrees.

5. The apparatus of claim 4, wherein the oblique angle is approximately 45 degrees.

6. The apparatus of claim 2, wherein the trough is positioned within the top housing member and insulated from user contact therewith.

7. The apparatus of claim 1, wherein the processing assembly comprises:
a collecting mechanism configured to separate at least metallic material from the received refuse;
a cutting mechanism configured to partition the received refuse into smaller portions; and
a motor configured to drive at least the cutting mechanism.

8. The apparatus of claim 7, wherein the collecting mechanism comprises a magnetized member configured to collect metallic material from refuse as the refuse travels towards the cutting mechanism by way of magnetic attraction.

9. The apparatus of claim 7, wherein the processing assembly further comprises a collection tray configured to receive the metallic material separated from the refuse.

10. The apparatus of claim 7, wherein the cutting mechanism comprises a roll mill having at least two rollers configured to cut, grind, shear, or pulverize the refuse into concentrated waste.

11. The apparatus of claim 1, wherein the processing assembly further comprises control circuitry configured to provide power to and control operation of at least the motor.

12. The apparatus of claim 11, further comprising at least one sensor module in electronic communication with the control circuitry and configured to sense the receipt of refuse within the top housing member, whereby operation of the motor and cutting mechanism is based on a sensing signal from the sensor module.

13. The apparatus of claim 11, further comprising at least one sensor module in electronic communication with the control circuitry and configured to sense proper loading of the at least one receptacle within the bottom housing member and in proper alignment with the processing assembly, whereby operation of the motor and cutting mechanism is based on a sensing signal from the sensor module.

14. The apparatus of claim 1, wherein the at least one receptacle is removable from the bottom housing member.

15. The apparatus of claim 1, wherein the at least one receptacle is composed of a recyclable material.

16. The apparatus of claim 1, wherein the at least one receptacle comprises a pop-up valve indicator configured to provide an indication of gas buildup within the receptacle.

17. A portable modular waste processing system comprising:
a top housing member housing a mechanical processing assembly configured to process waste to generate concentrated waste for subsequent use as a base fuel or substrate for energy generation; and
a bottom housing member releasably coupled to the top housing member and housing at least two recyclable receptacles configured to receive and store the concentrated waste, the bottom housing member comprises at least one door configured to allow removal of the two receptacles therefrom;
wherein the mechanical processing assembly comprises:
a collecting mechanism having a magnetized member configured to separate metallic material from waste by way of magnetic attraction and a collection tray configured to receive and retain the metallic material;
a cutting mechanism comprising a roll mill having at least two rollers configured to cut, grind, shear, or pulverize the waste into concentrated waste;
a motor configured to drive at least the cutting mechanism; and
control circuitry configured to provide power to and control operation of at least the motor.

18. The system of claim 17, wherein the top housing member comprises an opening configured to receive waste therethrough and a trough configured to guide the waste towards the mechanical processing assembly.

19. The system of claim 18, further comprising a weight sensor module coupled to the trough and in electronic communication with the control circuitry, the weight sensor module configured to sense the weight of waste on the trough, whereby operation of the motor and cutting mechanism is based on an activation signal from the weight sensor module in response to sensing of adequate weight of waste material.

20. The system of claim 18, further comprising at least one sensor module in electronic communication with the control circuitry and configured to sense proper loading of the two recyclable receptacles within the bottom housing member and in proper alignment with the processing assembly, whereby operation of the motor and cutting mechanism is based on an activation signal from the sensor module in response to sensing of proper loading of the receptacles.
